(19) United States
(12) Patent Application Publication
(10) Pub. No.: US 2005/0278957 A1
(43) Pub. Date: Dec. 22, 2005

(54) Cheese cutting apparatus

(76) Inventor: David K. McCullough, Coeur d'Alene, ID (US)

Correspondence Address: Randy A. Gregory;Gregory I.P. Law, P.O. Box 31090, Spokane, WA, 99223-3018, US

(21) Appl. No.: 10/870,098

(22) Filed: Jun. 16, 2004

(51) Int. Cl. A01D 1/00; B26B 13/00

(52) U.S. Cl. 30/279.6

(57) ABSTRACT

A cheese cutting apparatus with a cutter wire mounted in a taught condition between arms of a frame. The frame has a handle that extends oppositely from the frame arms. A drive is used to adjustably tension the cutting wire to a desired tension. A ratchet or other keeper or locking mechanism allows the tensioned wire to stay at a desired tension adjustment. A version with a thickness guide may be used to provide adjustment of the thickness of cheese slice cut.

### TECHNICAL FIELD

The present invention relates to cheese cutting apparatus and related methods.

### BACKGROUND OF THE INVENTION

Wire cheese cutters have been previously developed which produce less drag through a block of cheese than a knife. This makes cutting cheese easier. In most or all of such prior wire cheese cutters, the wire and/or wire support bend and break. This causes the cutting wire tension to decrease. Too little cutting tension in the wire detracts from the convenience and performance of such wire cheese cutters and has limited their use.

When the support frame breaks, these devices are rendered useless and it is not economical to fix the cheese cutter. In situations where the cutting wire breaks, most wire cheese cutters do not have a construction that allows maintenance and replacement of the wire with a new or substitute wire. This is often caused by designing for economical construction using permanent fixtures at each end or other mounting point for the cutting wire.

Such cheese cutters usually have a single wire mounted between two arms that extend from a central handle. It is typical that the wire is fixed to the arms at fittings and is pretensioned during manufacture and the tension is maintained by the arms, wire and frame. However, such cheese cutters often become loose at the fittings, or will bend, stretch and lose wire tension and consequently will lose cutting effectiveness. The arms also may spring or deform to relieve wire tension, causing looseness in the cutting wire to develop.

A variety of approaches have been used in an attempt to satisfy or prevent wire tension reduction or loss. Nonetheless, a need still exists for an improved wire cheese cutter that has an ability to maintain tension of the cheese cutting wire.

Another aspect of some wire cheese cutters is a depth guide that is supposed to maintain uniform thickness of the slices of cheese cut thereby. Although various approaches have been tried, it is still difficult to maintain slice thickness consistency. This is additionally difficult if the wire or other cutter element drifts or varies in any direction due to tension reduction.

The current invention has features or aspects that help to alleviate one or more of these problems of the prior art.

### BRIEF DESCRIPTION OF THE DRAWINGS

Preferred embodiments of the inventions are described herein with reference to the accompanying drawings which are briefly described below.

FIG. 1 is a perspective view showing a first cheese cutter according to the invention.

FIG. 2 is a top plan view of the cutter shown in FIG. 1.

FIG. 3 is a partial sectional view of the cutter shown in FIG. 1.

FIG. 4 is an enlarged sectional view of a preferred mechanism used in the embodiment of FIG. 1, the section plane is taken substantially along line 4-4 in FIG. 2.

FIG. 5 is an exploded or expanded perspective view of the drive and ratchet mechanisms shown partially in FIG. 4.

FIG. 6 is a perspective view of a second embodiment cheese cutter according to the inventions.

FIG. 7 is a top plan view of the cutter shown in FIG. 6.

FIG. 8 is a partial sectioned view of the cutter shown in FIG. 6.

FIG. 9 is a top plan view of another embodiment cheese cutter according to the inventions.

FIG. 10 is a top plan view of a further embodiment of cheese cutter according to the inventions.

### DETAILED DESCRIPTION OF THE PREFERRED EMBODIMENTS

Introductory Note

The readers of this document should understand that the embodiments described herein may rely on terminology used in any section of this document and other terms readily apparent from the drawings and language common therefor. This document is premised upon using one or more terms with one embodiment that will in general apply to other embodiments for similar structures, functions, features and aspects of the inventions. Wording used in the claims is also descriptive of the inventions and is incorporated by reference entirely as the claims are herein originally filed. Terminology used with one, some or all embodiments may be used for describing and defining the technology and exclusive rights associated herewith.

### First Embodiment Apparatus

General Configuration of First Embodiment Apparatus

The cheese cutters described herein are identified generally by reference numeral 10, and similar parts in the various embodiments are numbered the same. A first aspect includes a frame 12 with first and second arms 18, 20. The arms serve primarily as support arms to suspend the cutting wire and apply and/or maintain tension in the cutting wire 22.

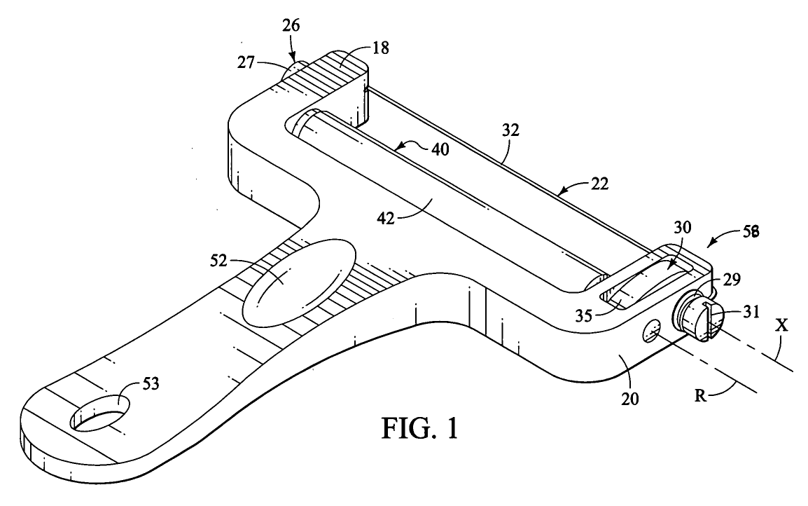

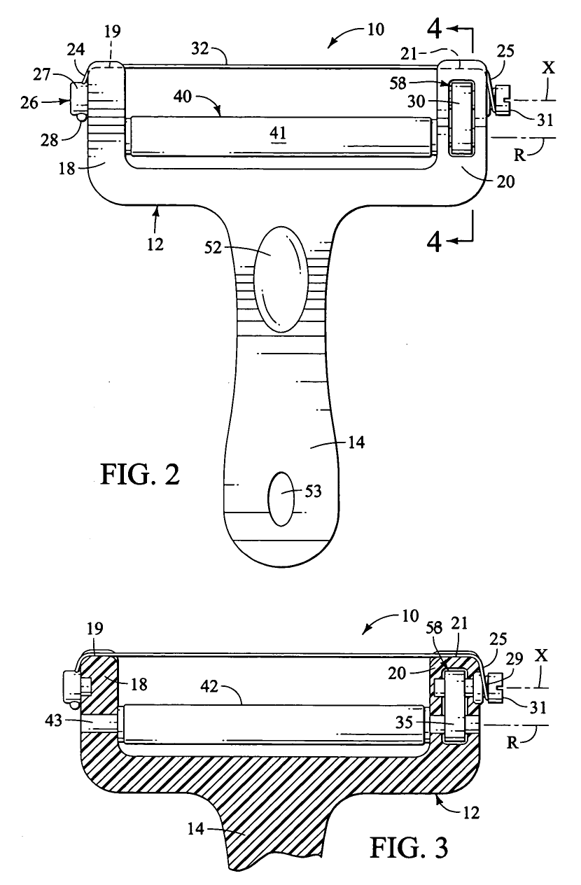

As shown in FIG. 1, an elongated cutter wire 22 extends between a first arm 18 and second arm 20. FIG. 2 shows opposing first and second end portions 24 and 25 of the cutting wire. Such end portions are used to connect the wire to the first and second arms.

FIGS. 1, 7 and 8 show that one of the fork arms 18, 20 may include a connector 26 that secures the first end 24 of the cutter wire 22 to first arm 18. A spool 29 is mounted to the opposing, second fork arm 20. Spool 29 is advantageously rotatable and receives the second end 25 of the cutting wire 22. The cutting wire 22 will thus extend across the throat space defined between the fork arms 18, 20. The cutting wire is taken up in response to rotation of the spool 29 in a first or tightening direction. A preferred ratchet mechanism 30 is connected to the spool 29 to act as a keeper to hold the spool in the adjustably tightened position. A toothed ratchet keeper permits incremental rotation of the spool 29 in discrete rotational increments in the first direction. This allows selective tensioning of the cutter wire 22 in increments defined by the ratchet teeth spacing.

Frame

FIG. 2 shows a frame 12 which is exemplary and illustrated in the drawings. Other configurations may be used according to the inventions described herein. It is advantageous that the frame be configured to include a handle 14 that extends in a direction generally opposite or opposing to the arms 18, 20. A yoke portion 16 (FIG. 7) joins the handle 14 and arms 18, 20 in the configuration shown herein. The handle can advantageously be provided with a hanging aperture 53 which allows the device to be hung on a nail or other hanger (not shown).

The frame can be constructed using known forming techniques, for example, by casting. It may be formed of a material or materials that are sufficiently rigid to permit and maintain tensioning of the cutter wire 22. Aluminum is a favored material but represents only one of many metal, polymer or other relatively rigid materials which may desirably be used. When aluminum is used, it may be advantageous to anodize the surface for durability and appearance.

The arms 18, 20, yoke 16, and handle 14 can be formed integral, as shown, or be provided as separate pieces that can be joined together to complete the frame configuration. Other frame shapes, configurations and constructions may alternatively be acceptable, depending on the overall design chosen.

Ends of the arms 18, 20 can be provided with aligned notches 19, 21 or be otherwise configured to receive, guide, and help secure the cutter 9 wire 22 such that a cutting or throat part 32 of the wire extends between the arms. As shown, the cutting wire is approximately perpendicular to the arms 18, 20. A variety of angular orientations may be alternatively workable. The arms may be provided with wire receiving apertures which may be bores (now shown) to receive and position the wire. Still further it is possible to use specially shaped passages (not shown) designed to distribute stress or for other purposes and effects.

Cutting or Cutter Wire

Preferred forms of cutter wire 22 are metal of a variety of types 2 suitable for food use and capable of withstanding considerable tension. The wire may desirably have sufficient flexibility to be wound around spool 29 in versions of the invention using a spool. The wire size may vary, but is preferably within a range of approximately 0.01 to 0.03 inches; more preferably 0.013 to 0.025; even more preferably 0.0135 to 0.0215. A nominal size of 0.165, 0.003 and 0.005 is preferred in the embodiment shown. Type 304 stainless steel is a preferred material type, although other food grade wires 9 may be suitable.

It is also advantageous to select wire that is formed of a material that is food grade, corrosion resistant and chemically stable, such as stainless 12 steel. Other materials, such as monofilament fishing line, polymers such as that sold by DuPont under the trademark KEVLAR®, and a variety of other materials may also be suitable.

The length of the wire can vary with the size of the frame 12 and 16 the distance between the forked or parallel arms 18 and 20. In preferred forms, the length will be sufficient to permit anchoring the first wire end 24 to 18 connector 26 and attachment of the second end 25 to spool 29. Further, the wire ends can be provided with loops, beads, or other connectors or forms that will facilitate mounting the cutting strand extending between the connector 26 and spool 29.

A bead 28 is exemplified in the drawings and can be used to secure the first end 24 of the wire to the mounting extension, such as stud 27. The remaining second end of the wire or other strand 25 is usually of uniform 6 size and without a bead to facilitate threading the strand through a holding aperture (see FIG. 5) in the spool 29.

Wire Connector

The first end 24 of cutter wire can be attached to the connector 26, which can be provided in the form of a stud 27 mounted on the first fork arm 18. The stud 27 can be integral with the fork arm or be attached in a conventional manner to provide secure anchorage for the cutter wire. The stud may be formed according to the configuration of the wire end (loop, bead or other connector configuration) to be used. For example, if the wire is to be provided with beaded ends, the stud can be bored to receive the wire but of a size that will not permit passage of the retaining bead 28.

Cutter Wire Drive

The invention further includes a cutter or cutting wire drive. The cutting wire drive functions to adjust the tension which is applied to and carried in the cutting wire or other cutting strand material. The drive must perform under the relatively difficult tension levels which provide easier cheese cutting and a superior performing apparatus.

The cutter functions by taking up a portion of the cutting wire or strand. In general, the more taken up by the strand drive, the greater the tension. This also provides a means for having adjustable tension in the cutting strand. Such capability may be desired for different cheeses or temperatures. The wire strand drive may advantageously also perform to retain the cutting wire end and act as storage therefor.

Cutter Wire Spool or Retainer

The apparatus according to this invention may include a spool or cutting wire retainer for taking wire. It may also serve in some capacity of driving or tensioning the cutting wire. In the illustrated form, spool 29 is mounted to the frame for rotation about a spool axis X. As shown, axis X-X may advantageously be substantially parallel to part 32 of the cutter wire 22 extending between the fork arms 18, 20. The illustrated spool is grooved about its circumference to receive and retain windings of the cutter wire, and bored transversely to receive and anchor second wire end 25. Other anchoring arrangements could also be used, including notches, hooks, set screws, or other wire end fastener arrangements that would provide anchorage for the wire, while permitting rotation of the spool.

To facilitate rotation about the spool axis X, the spool can be rotatably mounted in the frame 12, such as by using journals or other suitable bearings. In the illustrated example, the spool is rotatably mounted to the frame 12 by way of the journal bearings provided by the ratchet mechanism 30, without use of more expensive or specialty bearings, although alternatives such as these and many others could be used in some of the constructions made according to the invention.

FIG. 5 shows spool 29 is mounted along a common axis X-X upon a shaft extending from the drive and spool mechanism. This also supports the ratchet mechanism 30. Rotation imparted to the drive, such as at screw drive slot 31, is used to progressively wind the cutter wire onto the spool and draw the wire taut across the arms 18 and 20. Such rotation can be initiated by use of a variety of drive tools, such as: coins, kitchen knives, wrenches, screw drivers, and other torque transmitting driver tools which engage with a tool engagement head at the driver, such as 31.

The driver head 31 can be formed as exemplified in the drawings, for engagement with a standard coin or straight blade screw driver, or be otherwise shaped for engagement by other turning tools. For example, head 31 could be shaped as a polygon for engagement by a wrench, socket, pliers, or other such tool. Further, the surface 31 could be another form of incised or otherwise formed slot or pocket, shaped for another form of tool such as a hexagonal wrench, spanner, Phillips screw driver, or other driver tool form (not shown).

As another alternative, the surface 31 could be shaped to enable the user's fingers to become the turning tool. Thus, the surface could be in a butterfly or wing nut configuration, or another form of enlarged finger 13 engagement surface.

Latch or Keeper Mechanism

A latch, catch or other cutting wire tension keeper 58 is used to maintain cutting wire tension after the driver has been used to properly tension the cutting wire. It can be in the form of a pawl and ratchet mechanism 30 as described hereinabove. The latch or keeper permits incremental one-way rotation of the spool 29 or other driving mechanism. In the illustrated example, the mechanism is comprised of a ratchet wheel 34 that is advantageously secured to spool 29. A pawl 35 comprises the remaining part of the pawl and ratchet mechanism 30. The pawl is pivotably mounted by a shaft 38 supported by the frame. The pawl 35 engages the ratchet wheel 34 and only permits substantial rotation of the wheel and spool 29 in the first direction.

It is pointed out that the term “first direction” is used to indicate unidirectional rotation of the ratchet wheel and attached spool about the axis X. Such rotational direction could be clockwise or counter-clockwise since tightening the cutter wire could be the result of rotation in either direction, depending upon the orientation of the ratchet teeth 36 formed upon the ratchet wheel. However the “first direction” is only one of the rotational 14 directions, as determined by the ratchet mechanism.

The illustrated ratchet wheel 34 is provided with a plurality of teeth 36 spaced about the wheel perimeter, that are shaped to slide under the pawl as the spool is rotated in the first direction, and to engage the pawl to prevent rotation of the spool in the opposite direction. The ratchet wheel 34 can be an integral part of the spool 29, or be securely attached thereto so that rotation of the spool 29 is transmitted directly to rotation of the ratchet wheel 34.

The illustrated pawl 35 is a hooked device that is pivotably mounted to the frame 12. The pawl includes a pawl engagement tooth 37 that rides on the ratchet wheel 34 and slides over the ratchet teeth 36 as the wheel is turned in the first direction. The pawl engagement tooth engages against the ratchet wheel to prevent rotation in the opposite or second direction.

The pawl can be biased against the ratchet wheel by gravity, and held in place by operation of tension along the cutter wire. Alternatively, the pawl may be appropriately biased using a conventional torsion, leaf or other spring form (not shown) whereby the catch 37 can be normally biased toward the ratchet wheel.

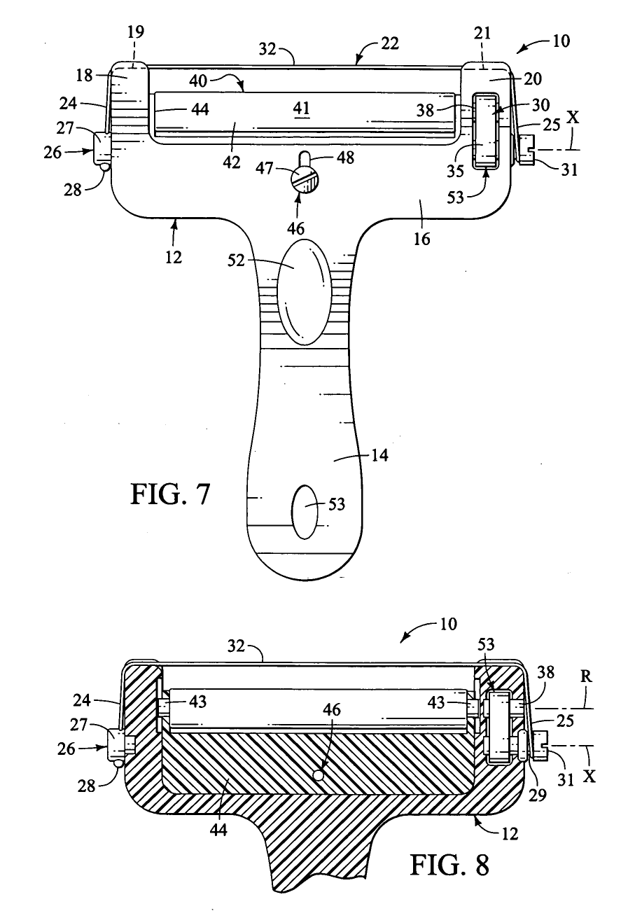

In one aspect, the pawl can be mounted to the axle of a thickness guide roller 42 (described in greater detail later) as shown in FIGS. 3 and 5. Otherwise the pawl 35 may be pivoted on its own hub 38 as shown in FIG. 8 and others.

Operation of the First Embodiment Apparatus

It is noted that the apparatus 10 described thus far may be assembled during manufacture, so the user need only see that the cutter wire is sufficiently taut before use. Actual use can also be a factor that can help in that determination.

If the cutter wire is too loose, the appropriate turning tool can be used to access the tool engagement head 31 of the driver to facilitate turning the spool 29 in the first direction until the desired tension is attained. The wire will remain taut unless it becomes slightly stretched with use, at which time the turning tool can be used again to re-tighten the cutting wire.

Should the wire not be assembled with the frame during manufacture, assembly is easily accomplished by attaching the first end 24 to the connector 26. The wire 22 is then extended across the ends of fork arms 18, 20 and fitted into the notches 19, 21 provided there. The second wire end 25 can next be threaded through or otherwise secured to the spool 29. The appropriate turning tool can now be used to wind the wire onto the spool until that part 32 of the wire extending between the fork arms 18, 20 becomes sufficiently taut, at which time the apparatus is ready for use.

### Second Apparatus Embodiment

General Description

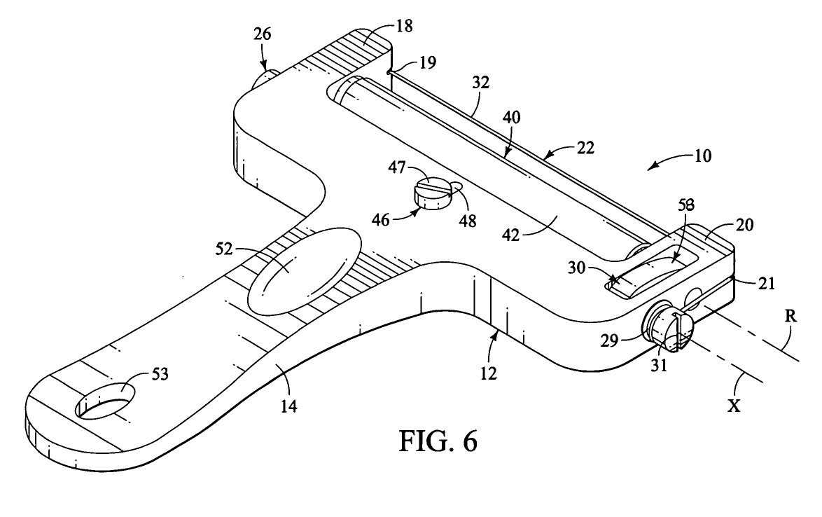

In many respects, the second embodiment apparatus of FIGS. 6-8 is similar or the same as the apparatus described above. Where material differences exist, additional explanation is given below. Parts and features which are the same or similar to those described are labeled with the same reference numbers and the description thereof will not be repeated but are incorporated by reference with regard to both forms.

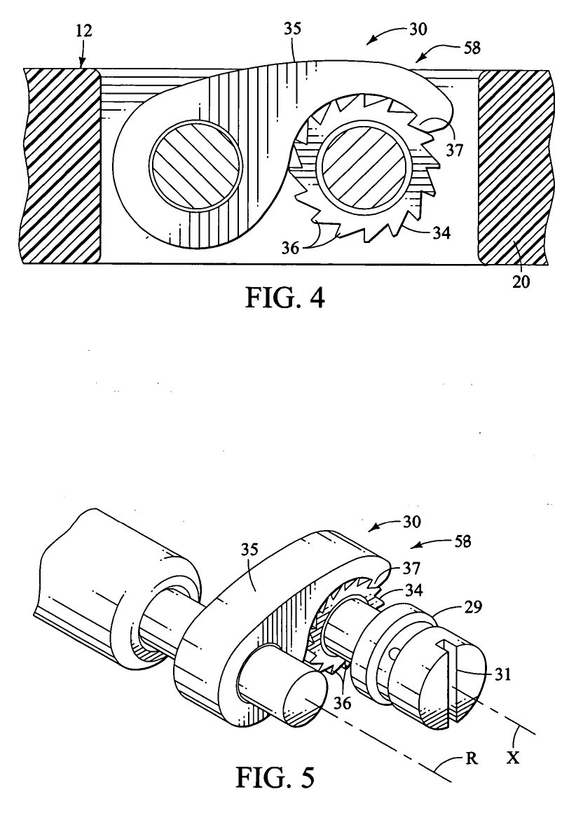

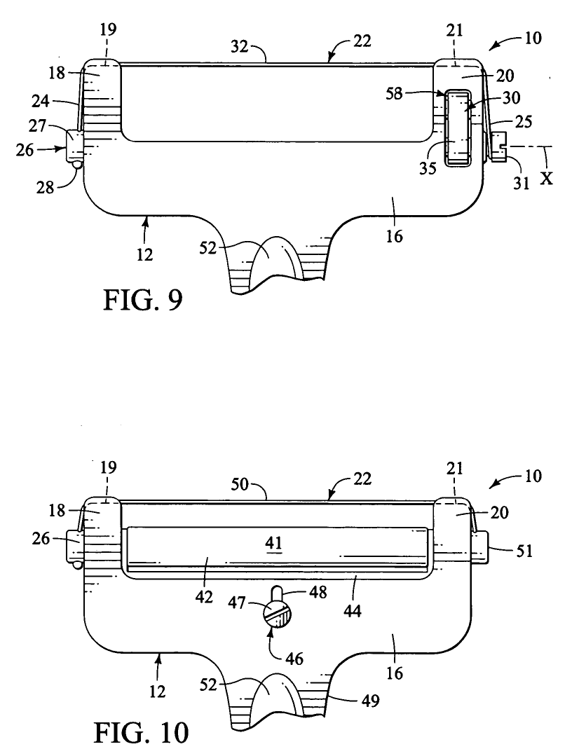

The primary difference between the second embodiment apparatus shown in FIG. 9 and those already described is the addition of a thickness guide 40 (FIGS. 1-8). Thus the second embodiment will generally include both common and new elements as generally set forth below.

The second embodiment of cheese cutter apparatus 10 can include the frame 12, and the first and second fork arms 18, 20 as described above. It can also include the elongated cutter wire 22, extending between a connector on one of the fork arms, securing the first end of the wire cutter, the spool 29 rotatably mounted to the second fork arm and receiving the second end 25 of the elongated cutter wire 22. The ratchet mechanism 30 or other keeper 58 can also be connected to the spool 29 as already described, permitting selective rotation of the spool in positive rotational increments in the first direction, to selectively and positively tension the cutter wire 22. However, the second embodiment cheese cutter also includes an adjustable thickness guide 40 that is mounted on the frame 12.

Thickness Guide

In a basic aspect, the thickness guide 40 is comprised of an outer surface 41 that is spaced a selected slice thickness dimension from that part 32 of the cutter wire 22 which extends between the fork arms 18, 20. It is advantageous that the guide contact or outer surface 41 be at least substantially parallel to the cutter wire 32. It is preferable that the guide be suitable for rolling or possibly slidable engagement against a cheese block. In the illustrated example, the guide surface 41 is provided on a guide roller 42.

In a basic form (FIGS. 2, 3), the guide roller 42 can be mounted on an axle 43 with ends supported by journals or other suitable bearings which are in fixed position in the frame. The journals are held by the arms 18, 20. The roller 42 can be formed of the same or different material as the frame, and may be mounted to freely rotate about a roller axis R. Axis R is preferably oriented at least substantially parallel to the throat portion 32 of the cutter wire 22 that extends between the fork arms 18, 20.

In another form, guide 40 can also include an adjustable thickness guide. This can be provided using a carriage 44 (FIG. 8), mounting the thickness guide 40 to the frame 12 for selective and adjustable movement toward and away from the cutter wire throat part 32. In the illustrated embodiments, the carriage 44 rotatably journals the roller axle 43, and holds the roller parallel to the cutter wire part 32.

The carriage 44 can be configured to span the distance between the arms 18, 20 and to slidably engage the arms, using them both for guidance and support. Further guidance and adjustment can be facilitated by thickness gauge locking device 46, that is operable to secure carriage 44 in a selected position.

FIGS. 6-8 show locking device 46 constructed using a set screw 47. The set screw 47 is received through a slotted aperture 48 formed in the frame 12. The exemplary screw 47 threadably engages the carriage 44 through the slot 48 by reception in threaded aperture 46. The set screw can be tightened to clamp and lock the carriage in a desired position as permitted by the geometry of the relevant parts. Slot 48 is preferably oriented to be substantially perpendicular to the guide surface 41 and the cutter wire. The screw can be loosened to allow adjustment of the carriage along the slot and thereby adjust the distance between the guide surface 41 and the throat segment of the cutter wire 32.

It is noted that the location of the slot 48 could be altered. That is, the slot could be formed in the carriage 44 and the screw 47 could be threaded into the frame 12. Other alternative constructions may be suitable for adjustably mounting the guide.

Alternative fasteners can also be used in place of the screw 47. For example, a bolt, thumb screw or other such fastener could be used. Further, other arrangements than the screw and slot can also be used to permit adjustment of the carriage 44. For example, a detent arrangement (not shown) could be used in place of the screw and slot arrangement to permit carriage adjustment.

Operation of the Second Embodiment

Operation of this embodiment is similar to the first embodiment as described above. Additionally, the thickness guide 40 can be loosed, adjusted, locked and used at different positions to determine thickness of the cheese slice cut.

To adjust for a different cut thickness, the carriage 44 may be selectively moved toward or away from the cutter wire part 32. This can be accomplished simply by loosening the set screw 47 to release the clamping or locking force between the carriage and frame, and by simply sliding the carriage to the desired position. Once the guide surface is in the desired location, the screw can be re-tightened to lock the contacting guide surface 41 in place.

### Third Apparatus Embodiment

General Description

In many respects, the third embodiment of the present apparatus 10 (FIG. 10) is similar or the same as apparatus described above, with the exception that the cutter wire is not provided with a ratchet mechanism or other latching keeper or lock. Thus, parts and features which are the same or similar to those described are labeled with the same reference numbers and the description thereof will not be repeated but are incorporated by reference with regard to all forms.

Thus an exemplary third embodiment of cheese cutter 10 includes a frame 49 with the same or similar fork arms 18, 20 as described. An elongated fixed cutter wire 50 extending across the arms between mounting studs 51, 52 or another appropriate wire end anchor arrangement. Thickness guide 40 as described above is used, along with the same or similar thickness guide carriage 44 mounting the thickness guide to the frame for selective movement toward and away from the cutter wire 50.

The wire 50 in this embodiment can be pre-tensioned during manufacture. Since no further tension adjustment is available, heavier gauge wire can be selected. Should the wire become slack, the user can have the option of replacing the apparatus, or having the manufacturer or an authorized repair or maintenance facility tighten or replace the wire.

Adjustment of the thickness guide and use of the third 13 embodiment cutter can be accomplished as already discussed, except that the cutter wire tension will remain without adjustment.

Further Aspects and Features

The above description has set out various features and aspects of the invention and the preferred embodiments thereof. Such aspects and features may further be defined according to the following claims which may individually or in various combinations help to define the invention.

Interpretation Note

The invention has been described in language directed to the current embodiments shown and described with regard to various structural and methodological features. The scope of protection as defined by the claims is not intended to be necessarily limited to the specific features shown and described. Other forms and equivalents for implementing the inventions can be made without departing from the scope of concepts properly protected hereby.

1. A cheese cutter apparatus, comprising:
a frame;
a handle forming part of said frame;
first and second arms projecting from the frame in spaced apart relation and in opposing direction from said handle;
a cutter wire extending between a first end and a second end;
a connector on one of the arms, securing the first end of the wire cutter;
a spool rotatably mounted to the second arm and receiving the second end of the elongated cutter wire in such a manner that the cutter wire will extend across the space between the arms, and be taken up in response to rotation of the spool in a first direction; and
a ratchet mechanism connected to the spool, permitting incremental rotation of the spool in positive rotational increments in the first direction, to selectively and positively tension the cutter wire.

2. An apparatus according to claim 1 and further comprising a thickness guide on the frame and spaced a selected slice thickness dimension from the throat of the cutter wire spanning the arms.

3. An apparatus according to claim 1, and further comprising a thickness guide spaced a selected slice thickness dimension from that part of the cutter wire which extends between the arms; and further comprising a thickness guide carriage mounting the thickness guide to the frame for selective movement toward and away from that part of the cutter wire spanning the arms.

4. An apparatus according to claim 1, and further comprising a thickness guide including a roller mounted on an axle with ends journaled by the arms, wherein the ratchet mechanism includes a ratchet wheel and a pawl, and wherein the pawl is pivotably mounted to one of the axle ends.

5. An apparatus according to claim 1, and further comprising a thickness guide including a roller mounted on an axle with ends journaled by the arms, wherein the ratchet mechanism includes a ratchet wheel and a pawl, wherein the pawl is pivotably mounted to one of the axle ends, and wherein the spool is mounted to the ratchet wheel for rotation therewith.

6. An apparatus according to claim 1 wherein the ratchet mechanism includes a ratchet wheel and a pawl; wherein the ratchet wheel is mounted to the spool for rotation therewith; and further comprising a turning tool engagement surface on the spool.

7. An apparatus according to claim 1 further comprising a guide roller rotatably mounted to the frame in spaced, at least substantially parallel relation to that part of the cutter wire extending between the arms.

8. An apparatus according to claim 1 further comprising a guide roller rotatably mounted to the frame in spaced, at least substantially parallel relation to a cutter wire extending between the arms, a carriage mounting the guide roller for translational movement toward and away from said cutter wire, and a locking device for securing the carriage in a selected position.

9. A cheese cutting apparatus, comprising:
a frame;
first and second arms projecting from the frame in spaced apart relation;
an elongated cutter wire extending between the first and second arms;
a thickness guide; and
a thickness guide carriage mounting the thickness guide between and slidably engaged with the arms for selective movement toward and away from the cutter wire.

10. An apparatus according to claim 9, further comprising a ratchet mechanism connected to one end of the cutter wire and operable to selectively tighten the cutter wire between the first and second arms.

11. An apparatus according to claim 9 wherein the carriage is slidably attached to the frame and further comprising a locking device for securing the carriage in a selected position.

12. An apparatus according to claim 9 and further comprising a ratchet mechanism mounted to the frame separately from the thickness guide carriage.

13. An apparatus according to claim 9 and further comprising, a ratchet mechanism mounted to the frame and including a pawl pivotably mounted to one of the arms and a ratchet wheel releasably engaging the pawl and mounting the spool for rotation therewith.

14. An apparatus according to claim 9 wherein the thickness guide is comprised of a roller rotatably mounted to the thickness guide carriage; and further comprising a ratchet mechanism mounted to the frame and including a pawl pivotably mounted to the frame, and a ratchet wheel releasably engaging the pawl and mounted in axial relationship to a spool for taking up the cutter wire.

15. A cheese cutter apparatus, comprising:
a frame;
a handle forming at least part of said frame; 3 first and second arms projecting from the frame in spaced apart relationship in opposition to said handle;
a cutter wire extending between the first and second arms;
a connector on one of the arms, securing a first end of the cutter wire;
a spool rotatably mounted to the second arm and receiving a second end of the cutter wire in such a manner that the cutter wire will extend across the space between the arms, and be taken up in response to rotation of the spool in a first direction;
a ratchet mechanism connected to the spool permitting selective rotation of the spool in positive rotational increments in the first direction, to selectively and positively tension the cutter wire; and
a thickness guide mounted on the frame and including a guide surface that is at least substantially parallel to and spaced by a selected slice thickness from the cutter wire.

16. An apparatus according to claim 15 wherein the thickness guide further comprises a carriage mounting the guide surface to the frame for movement toward and away from the cutter wire while holding the surface at least substantially parallel to the cutter wire; and
a locking device that is operable to secure the carriage in a selected position with respect to the cutter wire.

17. An apparatus according to claim 15 wherein the thickness guide further comprises a carriage mounting the guide surface to the frame for movement toward and away from the cutter wire while holding the surface at least substantially parallel to the cutter wire;
a locking device that is operable to secure the carriage in a selected position with respect to the cutter wire and comprised of a set screw fitted through a slot formed in the frame and threadably engaging the carriage, the slot being at least substantially perpendicular to the guide surface.

18. An apparatus according to claim 15 wherein the guide surface is comprised of a roller with ends that are rotatably mounted to the frame by a moveable carriage, and wherein the ratchet mechanism includes a ratchet wheel on the spool, and a pawl pivotably mounted to the frame on a hub that is separate from the roller ends.

19. An apparatus according to claim 15 wherein the spool is mounted to the frame about a spool axis that is at least substantially parallel to the guide surface.
